(19) United States
(12) Patent Application Publication
(10) Pub. No.: US 2015/0121046 A1
(43) Pub. Date: Apr. 30, 2015

(54) ORDERING AND BANDWIDTH IMPROVEMENTS FOR LOAD AND STORE UNIT AND DATA CACHE

(71) Applicant: Advanced Micro Devices, Inc., Sunnyvale, CA (US)

(72) Inventors: Thomas Kunjan, Sunnyvale, CA (US); Scott T. Bingham, Sunnyvale, CA (US); Marius Evers, Sunnyvale, CA (US); James D. Williams, Sunnyvale, CA (US)

(73) Assignee: Advanced Micro Devices, Inc., Sunnyvale, CA (US)

(21) Appl. No.: 14/523,730

(22) Filed: Oct. 24, 2014

Related U.S. Application Data
(60) Provisional application No. 61/895,618, filed on Oct. 25, 2013.

(51) Int. Cl. G06F 9/30; G06F 12/08

(52) U.S. Cl. CPC G06F 9/30043; G06F 12/0875; G06F 2212/452
USPC 712/225

(57) ABSTRACT

The present invention provides a method and apparatus for supporting embodiments of an out-of-order load to load queue structure. One embodiment of the apparatus includes a load queue for storing memory operations adapted to be executed out-of-order with respect to other memory operations. The apparatus also includes a load order queue for cacheable operations that ordered for a particular address.

### CROSS-REFERENCE TO RELATED APPLICATION(S)

This application claims the benefit of U.S. Provisional Application Ser. No. 61/895,618 filed on Oct. 25, 2014, which is hereby incorporated in its entirety by reference.

### TECHNICAL FIELD

The disclosed embodiments are generally directed to processors, and, more particularly, to a method, system and apparatus for improving load/store operations and data cache performance to maximize processor performance.

### BACKGROUND

With the evolution of advances in hardware performance two general types of processors have evolved. Initially when processor interactions with other components such as memory existed, instruction sets for processors were developed that included Complex Instruction Set Computers (CISC) these computers were developed on the premise that delays were caused by the fetching of data and instructions from memory. Complex instructions meant more efficient usage of the processor using processor time more efficiently using several cycles of the computer clock to complete an instruction rather than waiting for the instruction to come from a memory source. Later when advances in memory performance caught up to the processors, Reduced Instruction Set Computers (RISC) were developed. These computers were able to process instructions in less cycles than the CISC processors. In general, the RISC processors utilize a simple load/store architecture that simplifies the transfer of instructions to the processor, but as not all instructions are uniform nor independent, data caches are implemented to permit priority of the instructions and to maintain their interdependencies. With the development of multi-core processors it was found that principles of the data cache architecture from the RISC processor also provided advantages with the balancing instruction threads handled by multi-core processors.

The RISC processor design has demonstrated to be more energy efficient than the CISC type processors and as such is desirable in low cost, portable battery powered devices, such as, but not limited to smartphones, tablets and netbooks whereas CISC processors are preferred in applications where computing performance is desired. An example the CISC processor is of the x86 processor architecture type, originally developed by Intel Corporation of Santa Clara, Calif., while an example of RISC processor is of the Advanced RISC Machines (ARM) architecture type, originally developed by ARM Ltd. of Cambridge, UK. More recently a RISC processor of the ARM architecture type has been released in a 64 bit configuration that includes a 64-bit execution state, that uses 64-bit general purpose registers, and a 64-bit program counter (PC), stack pointer (SP), and exception link registers (ELR). The 64-bit execution state provides a single instruction set is a fixed-width instruction set that uses 32-bit instruction encoding and is backward compatible with a 32 bit configuration of the ARM architecture type. Additionally, demand has arisen for computing platforms that utilize the performance capabilities of one or more CISC processor cores and one or more RISC processor cores using a 64 bit configuration. In both of these instances the conventional configuration of the load/store architecture and the data cache lags in the performance capabilities for each of these RISC processor core configurations having the effect of causing latency in one or more of the processor cores resulting in longer times to process a thread of instructions. Thus the need exists for ways to improve the load/store and data cache capabilities of the RISC processor configuration.

### SUMMARY OF EMBODIMENTS

In an embodiment according the present invention a system and method includes queuing unordered loads for a pipelined execution unit having a load queue (LDQ) with out-of-order (OOO) de-allocation, where the LDQ picks up to 2 picks per cycle to queue loads from a memory and tracks loads completed out of order using a load order queue (LOQ) to ensure that loads to the same address appear as if they bound their values in order.

The LOQ entries are generated using a load to load interlock (LTLI) content addressable memory (CAM), wherein the LOQ includes up to 16 entries.

The LTLI CAM reconstructs the age relationship for interacting loads for the same address, considers only valid loads for the same address and generates a fail status on loads to the same address that are non-cacheable such that non-cacheable loads are kept in order.

The LOQ reduces the queue size by merging entries together when an address tracked matches.

In another embodiment, the execution unit includes a plurality of pipelines to facilitate load and store operations of op codes, each op code addressable by the execution unit using a virtual address that corresponds to a physical address from the memory in a cache translation lookaside buffer (TLB). A pipelined page table walker is included that supports up to 4 simultaneous table walks.

In yet another embodiment, the execution unit includes a plurality of pipelines to facilitate load and store operations of op codes, each op code is addressable by the execution unit using a virtual address that corresponds to a physical address from the memory in a cache translation lookaside buffer (TLB). A pipelined page table walker is included that supports up to 4 simultaneous table walks.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a block diagram of a processor according to an aspect of the present invention;

FIG. 3 is a block diagram of a page table walker and TLB MAB according to an aspect of the invention;

FIG. 4 is a table of page sizes according to an aspect of the invention;

FIG. 5 is a table of page sizes in relation to CAM tag bits according to an aspect of the invention;

FIG. 6 is a block diagram of a load queue (LDQ) according to an aspect of the invention;

FIG. 7 is a block diagram of a load/store using 3 address generation pipes according to an aspect of the invention;

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

The present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

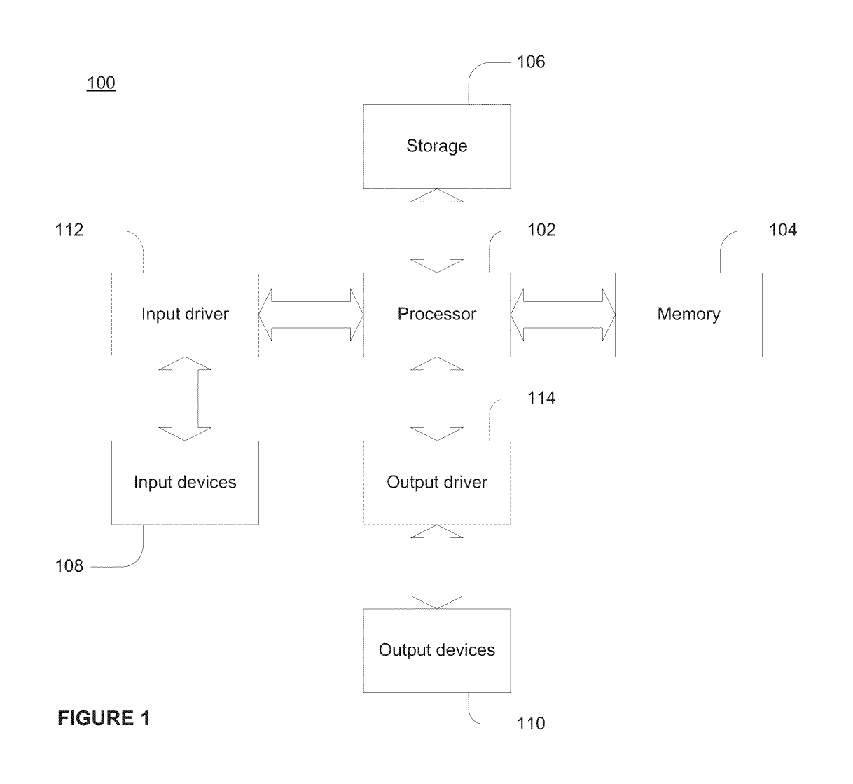

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

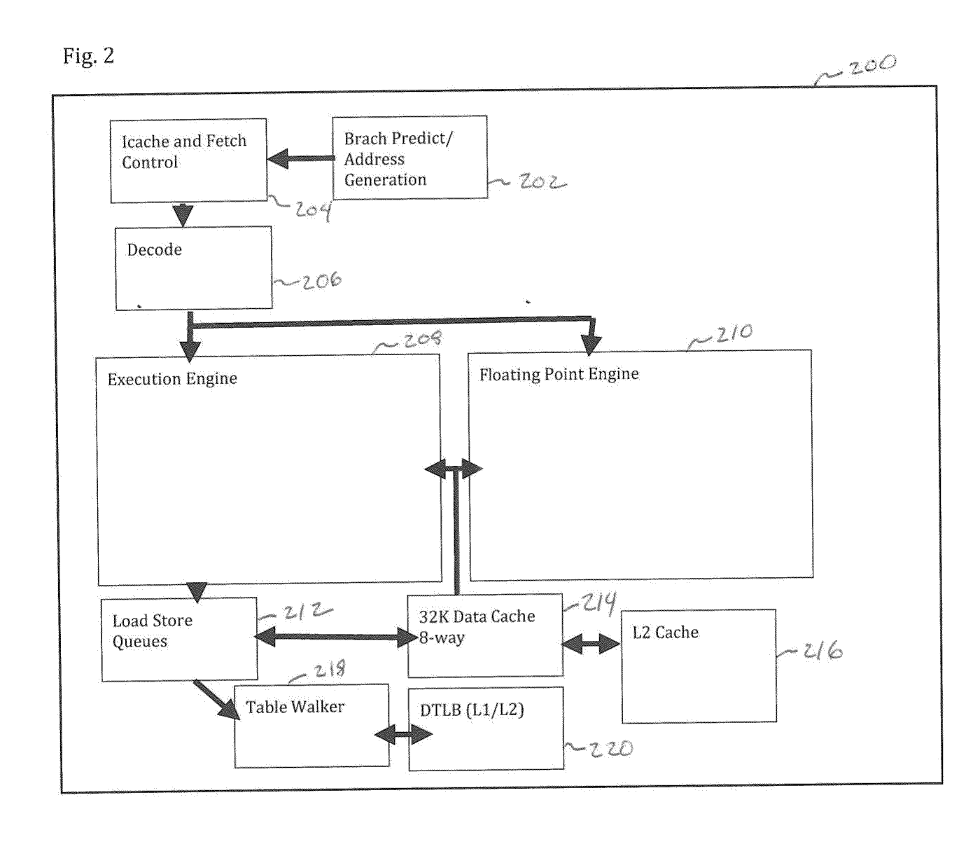

FIG. 2 is an exemplary embodiment of a processor core 200 that can be used as a stand-alone processor or in a multi-core operating environment. The processor core is a 64 bit RISC processor core such as processors of the Aarch64 architecture type that processes instruction threads initially through a branch prediction and address generation engine 202 where instructions are fed to an instruction cache (Icache) and prefetch engine 204 prior to entering a decode engine and processing by a shared execution engine 208 and floating point engine 210. A Load/Store Queues engine (LS) 212 interacts with the execution engine for the handling of the load and store instructions from a processor memory request and handled by a L1 data cache 214 supported by a L2 cache 216 capable of storing data and instruction information. The L1 data cache of this exemplary embodiment is sized at 32 kilobytes (KB) with 8 way associativity. Memory management between the virtual and physical addresses is handled by a Page Table Walker 218 and Data Translation Lookaside Buffer (DTLB) 220. The DTLB 220 entries may include a virtual address, a page size, a physical address, and a set of memory attributes.

Page Table Walker (PTW)

A typical page table walker is a state machine that goes through a sequence of steps. For architectures such as “x86” and ARMv8 that support two-stage translations for nested paging there can be as many as 20-30 major steps to this translation. For a typical page table walker to improve performance and do multiple page table walks at a time, one of ordinary skill in the art would appreciate one has to duplicate the state machine and its associated logic resulting in significant cost. Typically, a significant proportion of the time it takes to process a page table walk is waiting for memory accesses that are made in the process of performing a page table walk, so much of the state machine logic is unused for much of the time. In an embodiment a page table walker allows for storing the state associated with a partially completed page table walk in a buffer so that the state machine logic can be freed up for processing another page table walk while the first is waiting. The state machine logic is further “pipelined” so that a new page table walk can be initiated every cycle, and the number of concurrent page table walks is only limited by the number of buffer entries available. The buffer has a “picker” to choose which walk to work on next. This picker could use any of a number of algorithms (first-in-first-out, oldest ready, random, etc.) though the exemplary embodiment picks the oldest entry that is ready for its next step. Because all of the state is stored in the buffer between each time the walk is picked to flow down the pipeline, a single copy of the state machine logic can handle multiple concurrent page table walks.

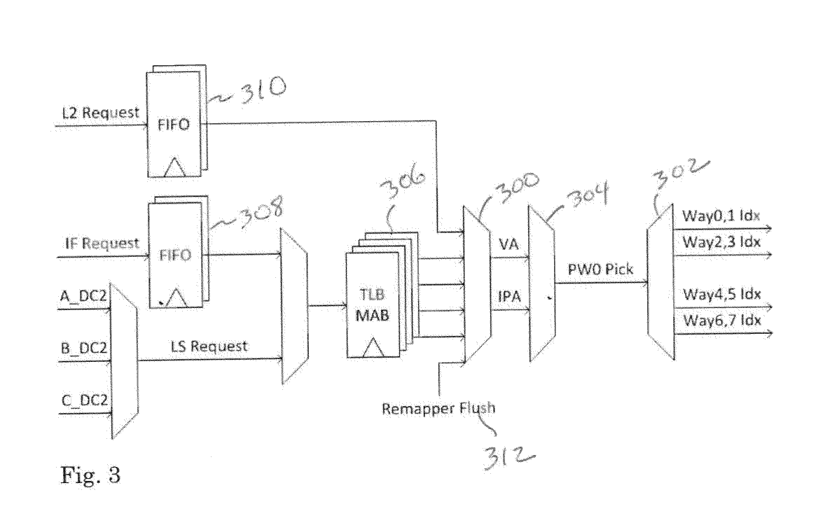

With reference to FIG. 3, the exemplary embodiment includes page table walker 300 that is a pipelined state machine that supports four simultaneous table walks and access to the L2 cache Translation Loookkaside Buffer (L2TLB) 302 for LS and Instruction Fetch (IF) included in the Icache and Fetch Control of FIG. 2. Switching context to the OS when resolving a TLB miss adds significant overhead to the fault processing path. To combat this, the page table walker provides the option of using built-in hardware to read the page-table and automatically load virtual-to-physical translations into the TLB. The page-table walker avoids the expensive transition to the OS, but requires translations to be in fixed formats suitable for the hardware to understand. The major structures for PTW are:

a) a L2 cache Translation Loookaside Buffer (L2TLB) 302 that includes 1024 entries with 8-Way skewed associativity and capable of 4 KB/64 KB/1M sized pages with partial translations capability;

b) Page Walker Cache (PWC) 304 having 64 entry with fully associative capability and capable of 16M and 512M sized pages with partial translations capability;

c) a Translation Lookaside Buffer—Miss Address Buffer (TLBMAB) 306 including a 4 entry pickable queue that holds address, properties, and the state of pending table walks;

d) IF Request Buffers 308 information such as virtual address and process state required to process translation requests from the Icache upon ITLB (instruction translation lookaside buffer) miss;

e) L2 Request Buffers 310 information such as virtual address and process state required to process translation requests from the Dcache upon DTLB (data translation lookaside buffer) miss; and

f) an Address Space IDentifier (ASID)/Virtual Machine IDentifier (VMID) remapper 312;

The basic flow of the PTW pipeline is to pick a pending request out of TLBMAB, access L2TLB and the PWC, determine properties/faults and next state, send fill, requests to LS to access memory, process fill responses to walk the page table, and write partial and final translations into the L1TLB, L2TLB, PWC and IF. The PTW supports nested paging, address/data (A/D) bit updates, remapping ASID/VMID, and TLB/IC management flush ops from L2.

PTW Paging Support

This section does not attempt to duplicate all of the architectural rules that apply to table walks so it is presumed that one of ordinary skill in the art would having a basic understanding of paging architecture for a RISC processor such as of the AArch64 architecture type in order to fully appreciate this description. But it should be understood that the page table walker of this exemplary embodiment supports the following paging features:
Properties from the stage2 page table walk generally apply to the stage1 translation but not the reverse.
EL1 (Exception Level 1) stage1 of a Translation Table Base Register (TTBR) may define two TTBR's, all other address spaces define a single TTBR.
Table walker gets the memtype, such as data or address of its fill requests from TTBR, Translation Control Register (TCR) or Virtual Translation Table Base Register (VTTBR).
TTBR itself may only produce an intermediate physical address (IPA) and needs to be translated when stage2 is enabled.
When the full address space is not defined, it is possible to start at a level other than L0 for a walk as defined by the Table size (TSize). This is always true for 64 KB granule and short descriptors.
Stage2 tables may be concatenated together when the top level is not more than 16 entries.
64 KB tables may be splintered when the stage2 backing page is 4 KB, resulting in multiple TLB entries for a top level table, for example, when Stage1 O/S indicates a 64 KB granule, then Stage2 O/S indicates 4 KB pages. The top level table for 64 KB may have more than 512 (4 KB/8B) entries. Normally one would expect this top level to be a contiguous chunk of memory with all the same properties. But the hypervisor may force it to be non-contiguous 4 KB chunks with different properties.
Bit fields of a page table pointer or entry are defined by the RISC processor architecture. For purposes of further understanding, but without limitation, where a RISC processor is of the Aarch64 architecture type one can consult the ARMv8-A Technical Reference Manual (ARM DDI0487A.C) published by ARM Holdings PLC of Cambridge, England, which is incorporated herein by reference.
All shareability is ignored and considered outershareable, where outershareable refers to devices on a bus separated by a bridge.
Outer memtypes are ignored and inner memtypes used only.
The table walk stops when it encounters a fault, unless it can be resolved non-specifically by Address/Date bit (Abit/Dbit) updates.
When MMU is disabled, PTW returns 4 KB translations to the L1TLB and the IFTLB using conventionally defined memtypes.
PTW sends a TLB flush when MMU is enabled.

The MMU (memory management unit) is a convetional part of the architecture and is implemented within the load/store unit, mostly in the page table walker.

Page Sizes

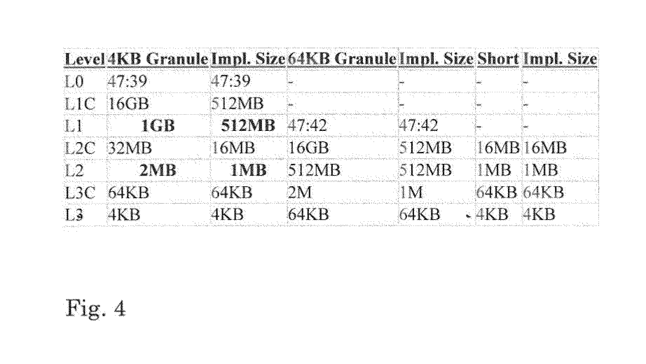

The table of FIG. 4 shows conventional specified page sizes and their implemented sized in an exemplary embodiment. Due to not supporting every page size, some may get splintered into smaller pages. The bold indicates splintering of pages that require multi-cycle flush twiddling the appropriate bit. Whereas, splintering contiguous pages into the base non-contiguous page size doesn't require extra flushing because it is just a hint. Rows L1C, L2C and L3C denote “contiguous” pages. The number of PWC and number of L2TLB divide the supported page sizes amongst them based on conventional addressing modes supported by the architecture. Hypervisor may force operating system (O/S) page size to be splintered further based on stage2 lookup where such entries are tagged as HypSplinter and all flushed when a virtual address (VA) based flush is used because it isn't feasible to find all matching pages by bit flipping. Partial Translations/Nested and Final LS translations are stored in the L2TLB and the PWC, but final instruction cache (IC) translations are not.

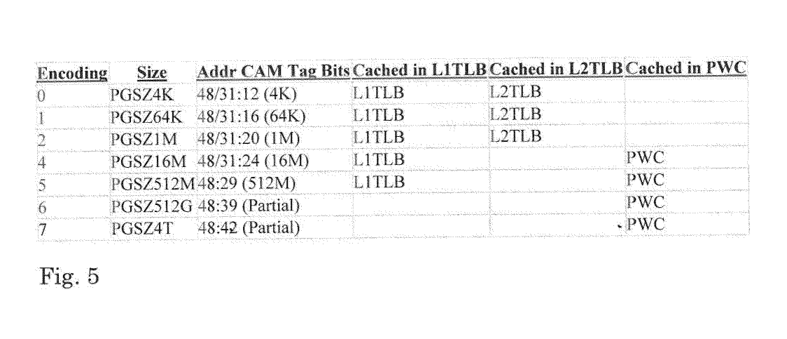

The structure caching different size pages/partials is indicated in the Table of FIG. 5, where the address for Content Addressable Memory (CAM) tag bits are also the translated bits of an address. Physical addresses may be up to bit 47 when using conventional 64 bit registers and the physical addresses may be up to bit 31 when using a conventional 32 bit registers.

Page Splintering

Pages are splintered for implementation convenience as per the page size table of FIG. 3. They are optionally tagged in an embodiment as splintered. When the hypervisor page size is smaller than the O/S page size, the installed page uses the hypervisor size and marks the entry as HypervisorSplintered. When a TLB invalidate (TLBI) by VA happens, HypervisorSplintered pages are assumed to match in VA and flushed if the rest of the operating mode CAM matches. Splintering done in this manner causes flush by VA to generate 3 flushes, one by requested address, and one by flipping the bit to get the other 512 MB page of a 1 GB page, and one by flipping the bit to get the other 1 MB page of a 2 MB page. The second two flushes only affect pages splintered by this method; unless TLBs don't implement that bit, then just any matching page.

In an embodiment, one may optimize and tag VMID/ASID as having any splintered pages in the remapper to save generating the extra flushes unnecessarily.

MemType Table

Implemented MemTypes:

| Encoding | Type |
|---|---|
| 3′b000 | Device nGnRnE |
| 3′b001 | Hypervisor Device nGnRnE |
| 3′b010 | Device GRE |
| 3′b011 | |
| 3′b100 | Normal NonCacheable/WriteThru |
| 3′b101 | Normal WriteBack NoAlloc |
| 3′b110 | Normal WriteBack Transient |
| 3′b111 | Normal WriteBack |

Conventional Memory Attribute Indirection Register (MAIR) memtype encodings are mapped into the supported memtypes of an embodiment to preserve cross platform compatibility. PTW is responsible for converting MAIR/Short descriptor encodings into the more restrictive of supported memtypes. Stage2 memtypes may impose more restrictions on the stage1 memtype. Memtypes are combined in always picking the lesser/more restrictive of the two in the table above. In should be noted that the Hypervisor device memory is specifically encoded to assist in trapping a device alignment fault to the correct place. The effect of Mbit-stage1 enable, VMbit-stage2 enable, Ibit-IC enable, Cbit-DC enable, and DCbit-Default Cacheable are overlayed on the resulting memtype as conventionally defined in the ARMv8-A Technical Reference Manual (ARM DDI0487A.C).

Access Permissions Table

| AP 2:0 | Non-EL0 Properties | EL0 Properties |
|---|---|---|
| 3′b000 | Fault | Fault |
| 3′b001 | Read/Write | Fault |
| 3′b010 | Read/Write | Read |
| 3′b011 | Read/Write | Read/Write |
| 3′b100 | Fault | Fault |
| 3′b101 | Read | Fault |
| 3′b110 | Read | Read |
| 3′b111 | Read | Read |

| HypAP [2:1] | Properties |
|---|---|
| 2′b00 | Fault |
| 2′b01 | Read |
| 2′b10 | Write |
| 2′b11 | Read/Write |

Access permissions are encoded using conventional 64-bit architecture encodings. When Access Permission bit (AP[0]) is access flag, it is assumed to be 1 in permissions check. Hypervisor permissions are recorded separately to indicate where to direct a fault. APTable affects are accumulated in TLBMAB for use in final translation and partial writes.

Faults

In an embodiment, a fault encountered by the page walker on a speculative request will tell the load/store/instruction that it needs to be executed non-speculatively. Permission faults encountered already installed in L1TLB are treated like TLB misses. Translation/Access Flag/Address Size faults are not written into the TLB. NonFaulting partials leading to the faulting translation are cached in TLB. Non-Speculative requests will repeat the walk from cached partials. The TLB is not flushed completely to restart the walk from memory. SpecFaulting translations are not installed then later wiped out. Fault may not occur on the NonSpec request, the if memory is changed to resolve the fault and that memory change is now observed. NonSpec faults will update the Data Fault Status Register (DFSR), Data Fault Address Register (DFAR), Exception Syndrome Register (ESR) as appropriate after encountering a fault. LD/ST will then flow and find the exception. The IF is given all the information to log its own prefetch abort information. Faults are recorded as stage1 or stage2, along with the level, depending on whether the fault came while looking up VA or IPA.

A/D-Bit Violations:

When access flag is enabled, it may result in a fault if hardware management is not enabled and the flag is not set. When hardware management is enabled, a speculative walk will fault if the flag is not set; a non-speculative walk will atomically set the bit. The same is true for Dirty-bit updates, except that the translation may have been previously cached by a load.

Security Faults:

If a non-secure access is attempted to a secure Physical Address (PA) range, a fault is generated.

Address Range Faults:

In an embodiment, device specific PA ranges are prevented from being accessed and result in a fault on attempt.

Permission Fault

The AP and HypAP define whether a read or write is allowed to a given page. The page walker itself may trigger a stage2 permission fault if it tries to read where it doesn't have permission during a walk or write during an Abit/Dbit update. A Data Abort exception is generated if the processor attempts a data access that the access rights do not permit. For example, a Data Abort exception is generated if the processor is at PL0 and attempts to access a memory region that is marked as only accessible to privileged memory accesses. A privileged memory access is an access made during execution at PL1 or higher, except for USER initiated memory access. An unprivileged memory access is an access made as a result of load or store operation performed in one of these cases:
When the processor is at PL0.
When the processor is at PL1 with USER memory access.

PTW LS Requests

LS Requests are arbitrated by L1TLB and sent to the TLBMAB, where the L1TLB and LS pickers ensure thread fairness amongst requests. LS requests arbitrate with IF requests to allocate into TLBMAB. Fairness is round robin with last to allocate losing when both want to allocate. No entries are reserved in TLBMAB for either IF or a specific thread. Allocation into TLBMAB is fair, try to allocate the requester not allocated last time. Because IF sits in a buffer and tries every cycle where LS will have to reflow to retry, when the livelock widget kicks in, we will have to remember LS nonspec op needs the TLBMAB and hold off allocating further IF requests until LS succeeds in allocating to the TLBMAB. The LS requests CAM TLBMAB before allocation to look for matches to the same 4K page. If a match is found, no new TLBMAB is allocated and the matching tag is sent back to LS. If TLBMAB is full, a full signal is sent back to LS for the op to sleep or retry.

PTW IF Requests

In an embodiment, IF Requests allocate into a token controlled two entry FIFO. As requests are read out and put into TLBMAB, the token is returned to IF. IF is responsible for being fair between threads' requests The first flow of IF requests suppress early wakeup indication to IF and so must fail and retry even if they hit in the L2TLB or the PWC. IF has their own L2TLB; as such, LS doesn't store final IF translations in LS L2TLB. Under very rare circumstances, LS and IF may be sharing a page and hence hit in together L2TLB or PWC on the first flow of an IF walk. But in order to save power and waking IF up in the common case, PTW instead suppresses the early PW0 wakeup being sent to IF and simply retries if there is hit in this instance which is rare. IF requests receive all information needed to determine IF-specific permission faults and log translation, size, etc. generic walk faults

PTW L2 Requests

The L2 cache may send IC or TLBI flushes to PTW through IF probe interface. Requests allocate a two entry buffer which capture the flush information over two cycles if TLBI. Requests may take up to four cycles to generate the appropriate flushes for page splintering as discussed above. Flush requests are given lowest priority in PW0 pick. IC flushes flow through PTW without doing anything, sent to IF in PW3 on the overloaded walk response bus. L2 requests are not acknowledged when the buffer is full. TLBI flushes flow down the pipe and flush L2TLB and PWC as above before being sent to both. LS and IF on the overloaded walk response bus, where such flushes look up the remapper as below before accessing CAM. Each entry has a state machine used for VA-based flushes to flip the appropriate bit to remove the splintered pages as discussed in greater detail above.

PTW State Machine

PTW state machine is encoded as Level, HypLevel, where the IpaVal qualifies whether the walk is currently in stage1 using VA or stage2 using IPA. TtbrIsPa qualifies whether the walk is currently trying to translate the IPA into a PA when ˜TtbrIsPa. It will be understood to one of ordinary skill in the art that the state machine may skip states due to hitting leaf nodes before granule sized pages or skip levels due to smaller tables with fewer levels. The state is maintained per TLBMAB entry and updated in PW3. The Level or HypLevel indicates which level L0, L1, L2, L3 of the page table actively being looked for. Walks start at 00,00,0,0 {Level, HypLevel, IpaVal, TtbrIsPA} looking for the L0 entry. With stage2 paging, it is possible to have to translate the TTBR first (00,00-11) before finding the L0 entry. L2TLB and PWC are only looked up at the beginning of a stage1 or stage2 walk to get as far as possible down the table. Afterwards, the walk proceeds from memory with entries written into L2TLB and/or PWC to faciliate future walks. Lookup may be re-enabled again as needed by NoWr and Abit/Dbit requirements. L2TLB and/or PWC hits indicate the level of the hit entry to advance the state machine. Fill responses from the page table in memory advance the state machine by one state until a leaf node or fault is encountered.

PTW Pipeline Logic:

PW0 minus 2:
LS L1TLB CAM
IF request writes FIFO

PW0 minus 1:
Arbitrate LS and IF request
LS request same 4 KB filtering
L2 request writes FIFO
Fill/Flow wakeup

PW0:
TLBMAB Pick—Oldest ready (backup FF1 from ready ops if timing fails)
L2 Flush Pick—L2 request picked if no TLBMAB picks or if starved L2TLB Read Predecode—PgSz per way selected and index partially decoded (This is a critical path)

PW1:
L2TLB 8-way read and addr/mode compare; priority mux hit
PWC CAM and priority mux hit

PW2:
L2TLB RAM read
PWC RAM read
Priority mux data source
Combine properties
Determine next state

PW3:
Send fill request to LS Pipe
Return final response to IF/LS
TLBMAB NoWr CAM for overlapping walks
L2TLB Write Predecode
TLBMAB Update, mark ready if retry
Abit/Dbit store produced

PW4:
L2TLB Write
PWC Write
LS L1TLB Write
LDQ/STQ Write

. . .

Retry and Sleep Conditions:
Walk will retry if its LS pipe request receives a bad status indication and cannot allocate a MAB or lock request cannot be satisfied or ˜DecTedOk is received on response.
Walk will retry if it encounters a read conflict following a L2TLB macro write.
Walk will retry after encountering and invalidating an L2TLB/PWC multi-hit or parity error.
Walk will retry to switch from VA->IPA flow Sleep waiting for LS pipe request to be picked.
Sleep waiting for fill request to return from L2.
Sleep if marked as an overlapping walk until leading walk is finished

Forward Progress/Starvation can occur where each TLBMAB entry and L2Flush request has a 8 bit (programmable) saturating counter. The counter is cleared on allocation or increments on another walk finishing. If a counter saturates by meeting a threshold value, only that entry may be picked until it finishes, other entries are masked as not ready. Where there are multiple page walks that expire together, this condition is resolve by FF1 from the bottom.

PTW Fill Requests

These diagrams show the various cases of PTW and LS pipe interactions. When the PTW does not hit in a final translation, it must send a load down the LS (AG & DC) pipe in order to grab the data (routed back through EX). The data is written to the TLBMAB and the PTW op woken up to rendezvous with the data. If there was an L1 miss, the PTW op generates a second load to rendezvous with the fill data from L2. Abit/Dbit updates require the load to obtain a lock and produce a store to update the page table in memory.

Example PTW pipe/LS pipe interactions are shown above

So PTW doesn't have to reflow when walks aren't picked to flow immediately in AG/DC pipe, a 2 entry FIFO is written.

When the walk is picked to flow in LS pipes, the entry is woken up in PTW to rendezvous with the data return.

If the flow makes a MAB request, the table walk is put to sleep on the MABTAG.

When the fill response comes, the FIFO is written again to inject a load to rendevous with the data in FillBypass. PTW supplies the memtype and PA of the load; and also an indication whether it is locked or not. The PTW device memory reads may happen speculatively and do not use NcBuffer, but must FillBypass. Requests are 32-bit or 64-bit based on paging mode; always aligned. Response data from LS routes through EX and is saved in TLBMAB for the walk to read when it flows. Poison data response results in a fault; data from L1 or L2 with correctable ECC error is re-fetched.

PTW A/D Bit Updates

When accessed and dirty flags are enabled and hardware update is enabled, the PTW performs atomic RMW to update the page table in memory as needed. A speculative flow that finds a Abit or Dbit violation will take a speculative fault to be re-requested as non-spec. An Abit update may happen for a speculative walk but only if the page table is sitting in WB memory and a cachelock is possible.

A non-spec flow that finds a Abit or Dbit violation will make a locked load request to LS, where PTW produces a load to flow down the LS pipe and acquire a lock and return the data upon lock acquisition. This request will return the data to PTW when the line is locked (or buslocked). If the page still needs to be modified, a store is sent to SCB in PW3/PW4 to update the page table and release the lock. If the page is not able to be modified or the bit is already set, then the lock is cancelled. When the TLBMAB entry flows immediately after receiving the table data, it sends a two byte unlocking store to SCB to update the page table in memory.

If the non-spec update is on behalf of a store that is able to update the Dbit, both the Abit and Dbit are set together. Because Abit violations are not cached in TLB, a non-spec request may first do an unlocked load in the LS pipe to discover the need for an Abit update. Because Dbit violations may be cached, the matching L2TLB/PWC entry is invalidated in the flow to consume the locked data as if it was a flush, where new entry is written when the flow reaches PW4. Since LRU picks invalid entries first, this is likely to be the same entry if no writes are ahead in the pipeline. L1TLB CAMs on write for existing matches following the dbit update.

PTW ASID/VMID Remapper

ASID Remapper is a 32 entry table of 16 bit ASIDs and VMID Remapper is a 8 entry table of 16 bit VMIDs. When a VMID or ASID is changed, it CAMs the appropriate table to see if a remapped value is assigned to that full value. If there is a miss, the LRU entry is overwritten and a core-local flush generated for that entry.
If the VMID is being reused, then a VMID-based flush is issued.
If the ASID is being reused, then a ASID-based flush is issued.
These flushes have highest priority in the PW0 pick.
Each thread may need up to two flushes.

PTW A/D Bit Updates 20

If there is a hit, the remapped value is driven to LS and IF for use in TLB CAMs. L2 requests CAM both tables on pick to find the remapped value to use in flush.
If there are no ASID hits and ASID is used in the flush match, the flush is a NOP.
If there are no VMID hits and VMID is used in the flush match, the flush is a NOP.
The remapped value is sent to L2TLB, PWC, L1TLB, and IF for use in flushing.
If the flush was to all entries of a VMID or ASID, then the corresponding entry is marked invalid in the remapper.

Invalid entries are picked first to be used before LRU entry. Allocating a new entry in the table does not update LRU. A Obit (programmable) saturating counter is maintained per entry. Allocating a TLBMAB for an entry increments the counter. When a counter saturates or operating mode switches to an entry with a saturated counter, the entry becomes MRU. LRU is maintained as a 7 bit tree for VMID and 2nd chance for ASID.

PTW Special Behaviors

To prevent multi-match for entries of the same page size, any write to PWC, L2TLB and/or L1TLB. CAMs the TLBMAB for overlapping walks, where walks that are hit are prevented from writing PWC, L2TLB and/or L1TLB until they look up the PWC and/or L2TLB again and they are also put to sleep until the leading walk finishes.

Load to Load Interlock (LTLI)

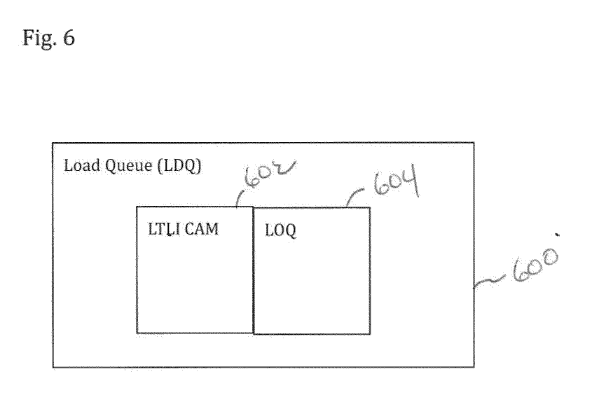

In an embodiment as shown in FIG. 6, conventional ordering rules only require loads to the same address to stay in order. The Load Queue (LDQ) 600 is unordered to allow non-interacting loads to complete while an older load remains uncompleted. To reconstruct the age relationship for interacting loads, a Load-ToLoad-Interlock (LTLI) CAM 602 similar to the Store To Load Interlock (STLI) CAM 602 for load-store interactions is performed at flow time. The LTLI CAM result is used to order non-cacheable loads, allocate the Load Order Queue (LOQ) 604, and provide a pickable mask for older ops. For non-cacheable loads, loads to the same address must be kept in order and will fail status on LTLI hits. For cacheable, loads to the same address must be kept in order and will allocate the LOQ 604 on LTLI hits. To approximate age, one leg of Ebit picks uses the age part of the LTLI hit to determine older eligible loads and provide feedback to trend the pick towards older loads.

Only valid loads of the same thread are considered for a match. Load to Load Interlock CAM consists of an age compare and an address match.

Age Compare:

Age compare check is a comparison between the RetTag+Wrap of flowing load and loads in LDQ. This portion of the CAM is done in DC1 with bypasses added each cycle for older completing loads in the pipeline that haven't yet updated LDQ.

Address Match:

Address Match for LTLI is done in DC3 with bypasses for older flowing loads. Loads that have not yet agen'd are considered a hit. Loads that have agen'd, but not gotten PA are considered a hit if the index matches. Loads that have a PA are considered a hit if the index and PA hash matches. Misaligned LDQ entries are checked for a hit on either MA1 or MA2 address, where a page misaligned MA2 does not have a separate PA hash to check against and is soley and index match.

Load Order Queue

LOQ is a 16 entry extension of the LDQ which tracks loads completed out of order to ensure that loads to the same address appear as if they bound their values in order. The LOQ observes probes and resyncs loads as needed to maintain ordering. To reduce the overall size of the queue, entries may be merged together when the address being tracked matches.

Per Entry Storage Table:

| Field | Size | Description |
|---|---|---|
| Val | 2 | Entry is valid for Thread1 or Thread0 (mutex) |
| Resync | 1 | Entry has been hit by a probe |
| WayVal | 1 | Entry is tracked using idx + way instead of idx + hash |
| Idx | 6 | 11:6 of entry address |
| Way | 3 | Way of entry |
| Hash | 4 | Hash of PA 19:16\hat{ }15:12 |
| LdVec | 48 | LDQ-sized vector of tracked older loads |

LOQ Allocation

In the absence of an external writer, loads to the same address may execute out of order and still return the same data. For the rare cases where a younger load observes older data than an older load, the younger load must resync and reacquire the new data. So that the LDQ entry may be freed up, a lighter weight LOQ entry is allocated to track this load-load relationship in case there is an external writer. Loads allocate or merge into the LOQ in DC4 based on returning good status in DC3 and hitting in LTLI cam in DC3. Loads need an LOQ entry if there are older, uncompleted same address or unknown address loads of the same thread.

Loads that cannot allocate due to LOQ full or thread threshold reached, must sleep until LOQ deallocation and force a bad status to register. In order to avoid reserving entries for the oldest load (possibly misaligned) per thread, loads sleeping on LOQ deallocation also can be woken up by oldest load deallocating. Loads that miss in LTLI may continue to complete even if no tokens are available. Tokens are consumed speculatively in DC3 and returned in the next cycle if allocation wasn't needed due to LTLI miss or LOQ merge.

Cacheline crossing loads are considered as two separate loads by the LOQ. Parts of load pairs are treated independently if the combined load crosses a cacheline.

In order to merge with an existing entry, the DC4 load CAM's the LOQ to find entries that match thread, index, and way or hash. If a CAM match is found, the LTLI hit vector from the DC4 load is OR'd into the entry's Load Order Queue Load Vetor (LoqLdVec). If a match is found in both Idx+Way and Idx+Hash, then the load is merged into the Idx+Way match. Each DC load pipe (A & B) performs the merge CAM.

New Entry Allocation:

A completing load CAM's the LOQ in DC4 to determine exception status (see Match below) and possible merge (see above). If there is no merge possible, the load allocates a new entry if space exists for its thread. An allocating entry records the 48 bit match from the LTLI cam of older address matching loads.

If the load was a DC Hit, it sets WayVal and records the Idx+Way in LOQ.

If the load was a DC Miss, it sets ˜WayVal and records the Idx+PaHash in LOQ.

If there are no LTLI matches (after considering same pipe stage, opposite pipe), the load does not allocate an LOQ entry.

Both load pipes may allocate in the same cycle, older load getting priority if only one entry free.

Same Cycle Load Interaction

It is possible that both pipes may have interacting loads flowing in the same pipe stage. A good status load in masks itself out of the opposite pipe LTLI CAM result as the loads could not be out of order * Loads committing in the same cycle to the same address should see the same data. To avoid multimatch, the two loads are compared in Idx+Way+Hash+Thread if both are good status:
If they are the same, the LTLI results are OR'd together to allocate or merge into the same entry.

If the hashes match but not the way, then the loads ignore Idx+Way matches in merging in DC4.

Complete loads in DC4, DC5, DC6 when the flowing load is in DC3 are also masked from the LTLI results, where older loads may not yet have updated Ldq if they are in the pipe so would appear in the LTLI cam of LDQ and need to be masked out/bypassed if they completed.

LOQ Match

Probes (including evictions) and flowing loads lookup the LOQ in order to find interacting loads that completed out of order. If an ordering violation is detected, the younger load must be redispatched to acquire the new data. False positives on the address match of the LTLI CAM can also be removed when the address of the older load becomes known.

Probe Match

Probes in this context mean external invalidating probes, SMT alias responses for the other thread, and L1 evictions—any event that removes readability of a line for the respective thread. Probes CAM the LOQ in RS6 with Thread+Idx+Way+PaHash with Way vs PaHash selected by WayVal, such that evictions read the tag array to get PA bits based on an indication from LOQ that there is an entry being tracked by PA hash. Probes from L2 generate an Idx+Way based on Tag match in RS3. For alias responses, a state read in RS5 determines the final state of a line and whether it needs to probe a given LOQ thread.

Probes that hit an LOQ entry mark the entry as needing to resync; the resync action is described below. For flowing ops that may allocate an LOQ entry too late to observe the probe, STA handles this probe comparison and LOQ entries are allocated as needing to resync, where this window is DC4-RS6 until DC2-RS8.

Flowing Load Match

Only DC pipe loads lookup the LOQ. A load completing with good status looks up the LOQ in DC4 to find entries for which the LdVec matches the LdqIndx of the flowing load (populated by a younger load's LTLI). If an entry has LoqResync and the corresponding bit position in LdVec for the flowing, completing load set, the flowing load is marked to resync trap as completion status and the LdVec bit position is cleared. Reusing the PaHash of the merge CAM, if the load does not match, the corresponding bit position in LdVec for all matching entries is cleared, such that the flowing load does not need to be completing in this flow to remove itself on a mismatch.

LOQ Deallocation

When a younger load completes out of order, it notes which older loads may possibly interact. Once those loads have completed, the LOQ entry may be reused as there is no longer a possibility of observing data out of order. LDQ flushes produce a vector of flushed loads that is used to clear the corresponding bits in all LOQ entries of LdVec's, where loads that speculatively populated an LOQ entry with older loads cannot remove those older loads if the younger doesn't retire.

When a LOQ entry has all of its LdVec bits cleared, it is deallocated and token returned. Many LOQ entries may deallocate in the same cycle. Deallocation sends a signal to LDQ to wake up any loads that may have been waiting for an entry to become free.

LOQ Special Behaviors

LOQ is not parity protected as such there will be a bit to disable the merge CAM.

Load and Store Pipeline

Dispatch Pipe

During dispatch all static information about a single op are provided by DE. This includes which kind of op, but excludes the address, which is provided later by EX. The purpose of the dispatch pipe is to capture the provided information in the load/store queues and feedback to EX which entries were used. This allows for up to 6 ops that can be dispatched per cycle (up to 4 loads and 4 stores). An early dispatch signal in DI1 is used for gating and allows for any possible dispatch next cycle, where the number of loads dispatched in the next cycle is provided in DI1. This signal is inclusively speculative and may indicate more loads than actually dispatched in the next cycle, but not less; however, the number of speculative loads dispatched should not exceed the number of available tokens. In this context, it should be noted that the token used for a speculative load which wasn't dispatched in the next cycle can't be reused until the next cycle. For example: If only one token is left, SpecDispLdVal should not be high for two consecutive cycles even if no real load is dispatched.

LSDC returns four LDQ indices for the allocated loads, indices returned will not be in any specific order, where loads and stores are dispatched in DI2. LSDC return one STQ index for the allocated stores, the stores allocated will be up to the next four from the provided index. The valid bit and other payload structures are written in DI4. The combination of the valid bit and the previously chosen entries are scanned from the bottom to find the next 4 free LDQ entries.

Address Generation (AG) Pipe

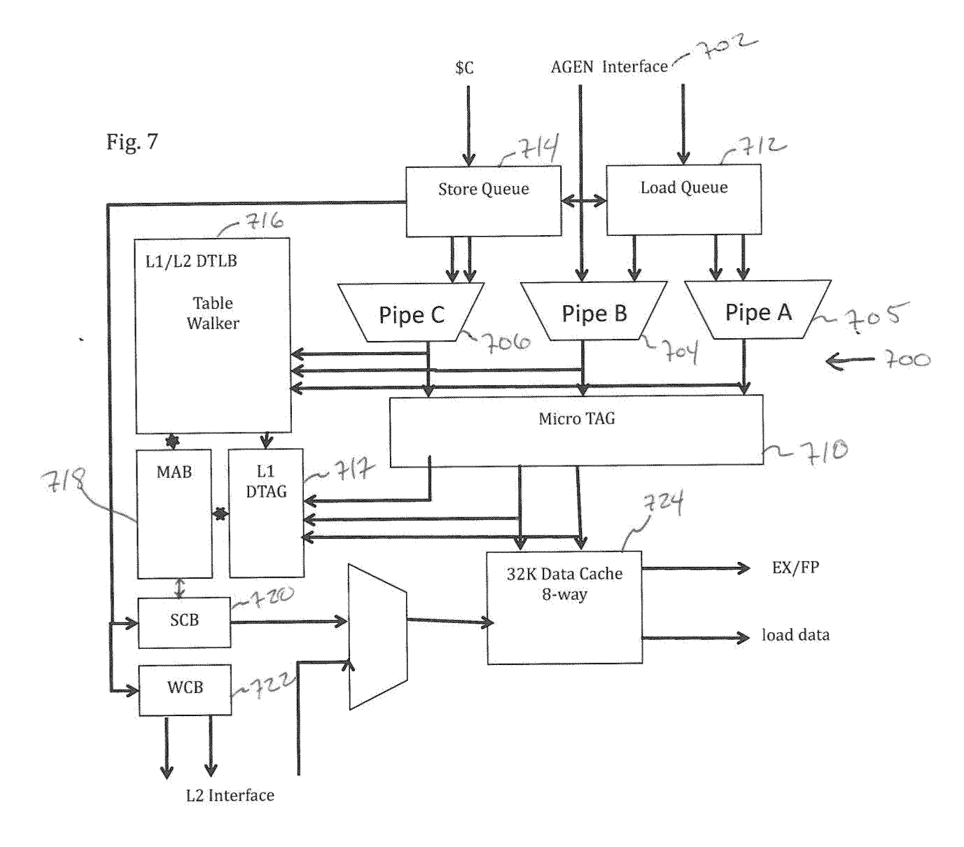

With reference to FIG. 7, during address generation 700 (also called agen, SC pick or AG pick) the op is picked by the scheduler to flow down the EX pipe and to generate the address 702 which is also provided to LS. After agen the op will flow down the AG pipe (maybe after a limited delay) and LS also tries to flow it down the LS pipe (if available) so that the op may also complete on that flow. EX may agen 3 ops per cycle (up to 2 loads and 2 stores). There are 3 agen pipes (named 0, 1, 2) or (B, A, C) 704, 705, 706. Loads 712 may agen on pipe 0 or 1 (pipe 1 can only handle loads), stores 714 may agen on pipe 0 or 2 (pipe 2 can only handle stores). All ops on the agen pipe will look up the μTAG array 710 in AG1 to determine the way, where the way will be captured in the payload at AG3 if required. Misaligned ops will stutter and lookup the μTAG 710 twice and addresses for ops which agen during MA2 lookup will be captured in 4 entry skid buffer. It should be noted that the skid buffer uses one entry per agen, even if misaligned, such that the skid buffer is a strict FIFO, no reordering of ops and ops in the skid buffer can be flushed and will be marked invalid. If the skid buffer is full then agen from EX will be stalled by asserting the StallAgen signal. After the StallAgen assertion there might be two more agens for which those additional ops also need to fit into the skid buffer. The LS is sync'd with the system control block (SCB) 720 and write combine buffer (WCB) 722. The ops may look-up the TLB 716 in AG1 if the respective op on the DC pipe doesn't need the TLB port. Normally, ops on the DC pipe have priority over ops on the AG pipe. The physical address will be captured in the payload in AG3 if they didn't bypass into the DC pipe. Load ops cam the MAB using the VA hash in AG1 and index-way/index-PA in AG2. AG1 cam is done to prevent the speculative L2 request on same address match to save power. The index-way/PA cam is done to prevent multiple fills to the same way/address. MAB is allocated and send to L2 in AG3 cycle. The stores are not able to issue MAB requests from the AG pipe C (store fill from AG pipe A can be disabled with a chicken bit). The ops on the agen pipe may also bypass into the data pipe of L1 724, where this is the most common case (AG1/DC1). The skid buffer ensures that AG and DC pipes stay in sync even for misaligned ops. Also, the skid buffer is also utilized to avoid single cycle bypass, i.e. DC pipe trails AG pipe by one cycle, such that this is done by looking if the picker has only one eligible op to flow. One of ordinary skill in the art would then understand that AG2/DC1 is therefore not possible, AG3/DC1 and AG3/DC0 are special bypass cases and AG4/DC0 onwards covered by pick logic when making repick decision in AG2 based on the μTAG hit.

Data Pipe

In an embodiment, there are three data pipes named 0, 1, 2, where loads can flow on pipe 0 or 1 and stores can flow on pipe 0 or 2. AG pipe 0 will bypass into DC pipe 0 if there is no LS pick, same applies for pipes 1 and 2, where there is no cross-pipe bypassing (e.g. AG 0 into DC 1). The LS picks have priority over SC picks (i.e. AG pipe bypass), unless DC pipe is occupied by the misaligned cycle of a previous SC pick. If the AG bypass into the DC pipe collides with a single DC pick (one cycle or two if misaligned), AG. The op will wait in skid buffer and then bypass into DC pipe.

The following table shows the relationship between AG and DC pipe flows of the same op:

| AG1 | AG2 | AG3 | AG4 | |
|---|---|---|---|---|
| DC1 | DC2 | DC3 | DC4 | direct bypass |
| DC0 | DC1 | DC2 | DC3 | not possible, AG will skid |
| PICK | DC0 | DC1 | DC2 | blindly bypass into LS picker, kill AG flow |
| | | | | if μTAG hit, kill DC flow if μTAG |
| | PICK | DC0 | DC1 | bypass into LS picker if μTAG hit |
| | | PICK | DC0 | regular LS pick after writing pick queue in |
| | | | | AG2 |

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. An integrated circuit comprising:
a memory; and
a pipelined execution unit having an unordered load queue (LDQ) with out-of-order (OOO) de-allocation and 2 picks per cycle to queue loads from the memory;
wherein the LDQ includes a load order queue (LOQ) to track loads completed out of order to ensure that loads to the same address appear as if they bound their values in order.

2. The integrated circuit of claim 1 wherein the LDQ includes a load to load interlock (LTLI) content addressable memory (CAM) to generate the LOQ entries.

3. The integrated circuit of claim 1 wherein the LOQ includes up to 16 entries.

4. The integrated circuit of claim 2 wherein the LTLI CAM reconstructs the age relationship for interacting loads for the same address.

5. The integrated circuit of claim 2 wherein the LTLI CAM only considers valid loads for the same address.

6. The integrated circuit of claim 2 wherein the LTLI CAM generates a fail status on loads to the same address that are non-cacheable such that non-cacheable loads are kept in order.

7. The integrated circuit of claim 2 wherein the LOQ resyncs loads as needed to maintain ordering.

8. The integrated circuit of claim 2 wherein the LOQ reduces the queue size by merging entries together when an address tracked matches.

9. The integrated circuit of claim 1 wherein the execution unit includes a plurality of pipelines to facilitate load and store operations of op codes, each op code addressable by the execution unit using a virtual address that corresponds to a physical address from the memory in a cache translation lookaside buffer (TLB); and
a pipelined page table walker supporting up to 4 simultaneous table walks.

10. The integrated circuit of claim 1 wherein the execution unit includes a plurality of pipelines to facilitate load and store operations of op codes, each op code addressable by the execution unit using a virtual address that corresponds to a physical address from the memory in a cache translation lookaside buffer (TLB); and
a pipelined page table walker supporting up to 4 simultaneous table walks.

11. A method comprising:
queuing unordered loads for a pipelined execution unit having a load queue (LDQ) with out-of-order (OOO) de-allocation; and
picking up to 2 picks per cycle to queue loads from a memory;
tracking loads completed out of order using a load order queue (LOQ) to ensure that loads to the same address appear as if they bound their values in order.

12. The method of claim 11 includes generating the LOQ entries using a load to load interlock (LTLI) content addressable memory (CAM).

13. The method of claim 11 wherein the LOQ includes up to 16 entries.

14. The method of claim 12 includes reconstructing the age relationship for interacting loads for the same address.

15. The method of claim 12 includes considering only valid loads for the same address.

16. The method of claim 12 includes generating a fail status on loads to the same address that are non-cacheable such that non-cacheable loads are kept in order.

17. The method of claim 12 includes resyncing loads in the LOQ as needed to maintain ordering.

18. The method of claim 12 includes reducing a queue size of the LOQ by merging entries together when an address tracked matches.

19. A computer-readable, tangible storage medium storing a set of instructions for execution by one or more processors to facilitate a design or manufacture of an integrated circuit (IC), the IC comprising:
a pipelined execution unit having an unordered load queue (LDQ) with out-of-order (OOO) de-allocation and 2 picks per cycle to queue loads from a memory;
wherein the LDQ includes a load order queue (LOQ) to track loads completed out of order to ensure that loads to the same address appear as if they bound their values in order.

20. The computer-readable storage medium of claim 19, wherein the LDQ includes a load to load interlock (LTLI) content addressable memory (CAM) to generate the LOQ entries.

21. The computer-readable storage medium of claim 19, wherein the instructions are hardware description language (HDL) instructions used for the manufacture of a device.
